(19) United States
(12) Patent Application Publication
(10) Pub. No.: US 2020/0361026 A1
(43) Pub. Date: Nov. 19, 2020

(54) LASER PROCESSING MACHINE AND FOCUS ADJUSTMENT METHOD

(71) Applicant: Murata Machinery, Ltd., Kyoto-shi (JP)

(72) Inventors: Shuji Kawakatsu, Kyoto-shi (JP); Wataru Shimizuhira, Kyoto-shi (JP)

(21) Appl. No.: 16/758,072

(22) PCT Filed: Oct. 26, 2018
(86) PCT No.: PCT/JP2018/039803

§ 371 Date: Apr. 22, 2020

(30) Foreign Application Priority Data
Nov. 7, 2017 (JP) 2017-214385

(51) Int. Cl. B23K 26/03; B23K 26/046; B23K 26/06; B23K 26/14

(52) U.S. Cl. CPC B23K 26/032; B23K 26/046; B23K 26/1464; B23K 26/0665; B23K 26/0648

(57) ABSTRACT

A laser processing machine includes a laser generator, assist gas supply tube, a light part, an imaging part, an acquisition part, and an adjustment part. The assist gas supply tube adjusts pressure of an assist gas and supplies the assist gas which is a gas injected from an irradiation port to an inner nozzle space. The imaging part images a workpiece by detecting a reflected light which is illumination light from the light part reflected by the workpiece through a portion of a laser beam passing space. The acquisition part acquires focal information which is a change amount of an imaging focal position according to the gas pressure in the inner nozzle space or is information for compensating the change amount. The adjustment part adjusts at least one of an imaging focal position and a position of the imaging part based on the focal information acquired by the acquisition part.

### TECHNICAL FIELD

This disclosure relates mainly to a laser processing machine that processes a workpiece by irradiation of a laser beam.

### BACKGROUND

Conventionally, a laser processing machine that includes a laser generator and performs processing such as punching, cutting, markings, and welding by irradiating a workpiece which is an object for process with a laser beam. That type of the laser processing machine may be configured to obtain an image of workpiece during processing to confirm a processed shape of the workpiece. Japanese Patent Application Laid-Open No. 2016-123980 discloses a laser processing machine having such a configuration.

The laser processing machine of JP '980 includes a laser beam source, a camera unit, a laser focus adjustment part, and a camera focus adjustment part. The laser beam source is disposed within a head and generates laser that illuminates an object (a workpiece). The camera unit is disposed within the head and acquire an image of the object. The laser focus adjustment part adjusts a focus of an irradiation location of the laser beam based on a thickness of the object, for example. The camera focus adjustment part adjusts a focus of the camera independently of the laser focus adjustment part.

A laser processing machine may be provided with a gas supply part that supplies an assist gas to assist a processing of a workpiece by a laser beam. However, JP '980 does not disclose this type of a gas supply part. JP '980 does not disclose anything about adjusting the focus of the laser processing machine comprising the gas supply part.

It could therefore be helpful to provide a laser processing machine including a gas supply part that supplies an assist gas and a configuration that acquires a clear image of a workpiece by appropriately adjusting a focus of a camera.

### SUMMARY

We provide a laser processing machine configured as follows. That is, the laser processing machine includes a laser generator, a laser optical system, a gas supply part, a light part, an imaging part, an imaging optical system, an acquisition part, and an adjustment part. The laser generator generates a laser beam for processing a workpiece. The laser optical system includes a condenser lens that condenses the laser beam generated by the laser generator, a nozzle disposed under the condenser lens, and a protection plate disposed between the condenser lens and the nozzle. Inner nozzle space located between a lower end of the nozzle and the protection plate is a constant volume semi-enclosed space. The laser optical system guides the laser beam so that the laser beam is irradiated to the workpiece through an irradiation port positioned at the lower end of the nozzle. The gas supply part adjusts pressure of an assist gas which is a gas injected from the irradiation port and assists processing of the workpiece by the laser beam, and supplies the assist gas to the inner nozzle space. The light part generates illumination light that illuminates the workpiece. The imaging part images the workpiece by detecting a reflected light which is the illumination light from the light part reflected by the workpiece through a portion of laser beam passing space. The imaging optical system guides the reflected light to the imaging part. The acquisition part acquires focal information which is a change amount of an imaging focal position according to the gas pressure of the assist gas in the inner nozzle space or is information for compensating the change amount. The adjustment part adjusts at least one of the imaging focal position and the position of the imaging part based on the focal information acquired by the acquisition part.

As a result, since the inner nozzle space (the semi-enclosed space) having the constant volume is formed by the lower end of the nozzle and the protection plate, pressure change of the inner nozzle space and refractive index change of the inner nozzle space are correlated with each other. Therefore, the adjustment of at least one of the imaging focal position and the position of the imaging part according to the pressure of the inner nozzle space enables the acquisition part to acquire the clear image of the workpiece.

In the laser processing machine, it is preferable that the gas supply part includes a pressure adjustment valve that adjusts a supply pressure of the assist gas and a pressure sensor disposed at a nozzle side than the pressure adjustment valve.

Accordingly, since the pressure of the inner nozzle space can be detected by the pressure sensor, the adjustment part can more appropriately adjust at least one of the imaging focal position and the position of the imaging part.

In the laser processing machine, it is preferable that a gas storage part that is an annular space surrounding the inner nozzle space is formed, and the assist gas is supplied to the inner nozzle space through the gas storage part.

As a result, since pressure distribution of the inner nozzle space is uniform, the inner nozzle space is static. That causes the correlation of the pressure and the refractive index of the inner nozzle space to be high. Therefore, the adjustment part can more appropriately adjust at least one of the imaging focal position and the position of the imaging part.

The laser processing machine preferably includes the following features. That is, the gas supply part is capable of supplying the assist gas selected from a plurality of types of the assist gas. The focal information is the change amount of the imaging focal position according to the type and the gas pressure of the assist gas or the information for compensating the change amount.

Accordingly, since the adjustment part adjusts taking into account not only the gas pressure of the assist gas, but also the type of the assist gas, the clearer image of the workpiece can be acquired.

It is preferable that the acquisition part acquires the focal information based on the data in which the gas pressure of the assist gas and the focal information corresponding to the gas pressure are associated with each other and the gas pressure supplied by the gas supply part.

This enables the acquisition part to acquire the focal information with a simple process.

It is preferable that the acquisition part acquires the focal information by analyzing the image of the workpiece acquired by the imaging part in a state where the laser beam is not irradiated to the workpiece and the gas supply part supplies the assist gas.

Accordingly, since there is relationship between the imaging focal position and the image of the workpiece, the acquisition part acquires the appropriate focal information by analyzing the image.

It is preferable that the acquisition part calculates the focal information based on the gas pressure of the assist gas supplied by the gas supply part and a relational expression indicating a relationship between the gas pressure and the focal information.

As a result, it is possible to reduce the amount of processes to be performed in advance, compared to a configuration creating databases in which the gas pressure and the focal information are associated with each other.

It is preferable that the adjustment part adjusts at least one of the imaging focal position and the position of the imaging part before the workpiece is processed by the laser generator and the gas supply part.

As a result, the process can start with the imaging focal position coinciding with the imaging part.

It is preferable that the adjustment part further adjusts a workpiece focal position of the laser optical system and the imaging optical system.

As a result, the process is performed while the workpiece focal positions of the laser optical system and the imaging optical system coincide with the surfaces of the workpiece.

The laser processing machine preferably includes the following features. That is, the imaging optical system includes a imaging lens that images an image on the imaging focus. The adjustment part adjusts the imaging focal position by moving the imaging lens along an optical axis.

This makes it possible to coincide the imaging focal position to the imaging part with a simple configuration.

It is preferable that the adjustment part coincides the position of the imaging part to the imaging focal position by moving the imaging part along an optical axis.

This makes it possible to coincide the imaging focal position to the imaging part with a simple configuration.

The laser processing machine preferably includes the following features. That is, the imaging optical system includes a variable focus lens being capable of changing a focal length. The adjustment part adjusts the imaging focal position by changing the focal length of the variable focus lens.

Accordingly, a drive mechanism that drives the imaging lens, the imaging part, and the like can be omitted when the adjustment is performed by using only the variable focus lens.

The laser processing machine preferably includes the following features. That is, the imaging optical system includes a first optical component common to the laser optical system and a second optical component not common to the laser optical system. The adjustment part adjusts at least one of the imaging focal position and the position of the imaging part by using the imaging part or the second optical component.

This prevents the focal position of the laser optical system from changing when the imaging focal position is adjusted.

The laser processing machine preferably includes the following features. That is, the imaging part can perform a first process mode that processes and images the workpiece while the gas supply part supplies the assist gas and a second process mode that processes and images the workpiece while the gas supply part does not supply the assist gas. Only the first process mode of the first process mode and the second process mode compensates the change of the imaging focal position according to the gas pressure of the assist gas.

This make it possible to provide the laser processing machine in which the clear image of the workpiece can be used both in processing with the assist gas and in processing without the assist gas.

We provide a focus adjustment method having a following features. That is, in the focus adjustment method, a process including an acquisition step and an adjustment step is performed. In the acquisition step, focal information which is a change amount of an imaging focal position according to a gas pressure of an assist gas in an inner nozzle space or which is information for compensating the change amount is acquired. In the adjustment step, at least one of an imaging focal position and a position of an imaging part is adjusted based on the focal information acquired in the acquisition step.

As a result, even when a refractive index changes due to pressure change caused by supply of the assist gas and the imaging focal position of imaging optical system changes, the acquisition part can acquire a clear image of a workpiece by performing the above-described adjustments to cancel the change of the imaging focal position.

### BRIEF DESCRIPTION OF THE DRAWINGS

FIG. 1 is a schematic cross-sectional view showing a configuration of a laser processing machine according to a first example.

FIG. 2 is a block diagram of the laser processing machine.

FIG. 3 is a view showing change of an imaging focal position by an assist gas and one of its compensating methods.

FIG. 4 is a flow chart showing processes for creating a focus adjustment table.

FIG. 5 is a flow chart showing processes for adjusting the imaging focal position by using the focus adjustment table

FIG. 6 is a flow chart showing processes for adjusting the imaging focal position in a second example.

FIG. 7 is an explanatory view showing a principle for adjusting the imaging focal position in a third example.

FIG. 8 is an explanatory view showing a principle of adjusting the imaging focal position in a fourth example.

### REFERENCE SIGNS LIST

1 laser processing machine
10 machining head
11 nozzle
12 protection plate
14 inner nozzle space
20 laser generator
30 light part
40 imaging part
50 assist gas supply tube (gas supply part)
60 control part
60a acquisition part
60b adjustment part
101 laser optical system
102 illumination optical system
103 imaging optical system

### DETAILED DESCRIPTION

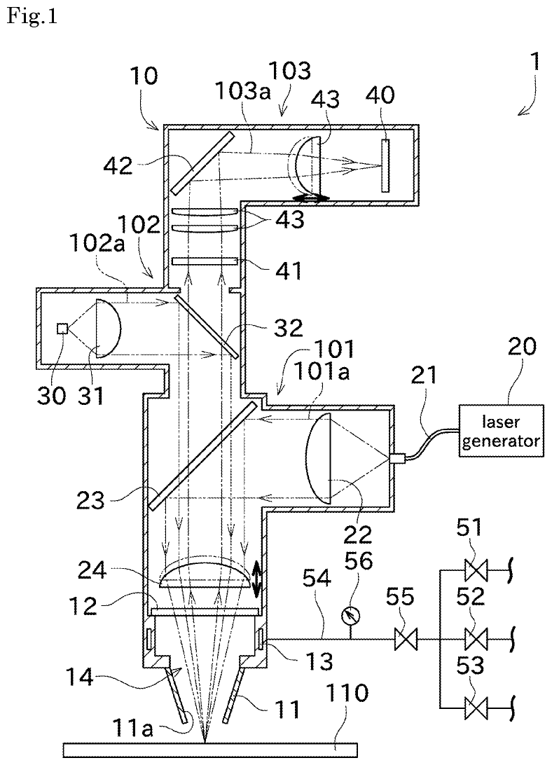

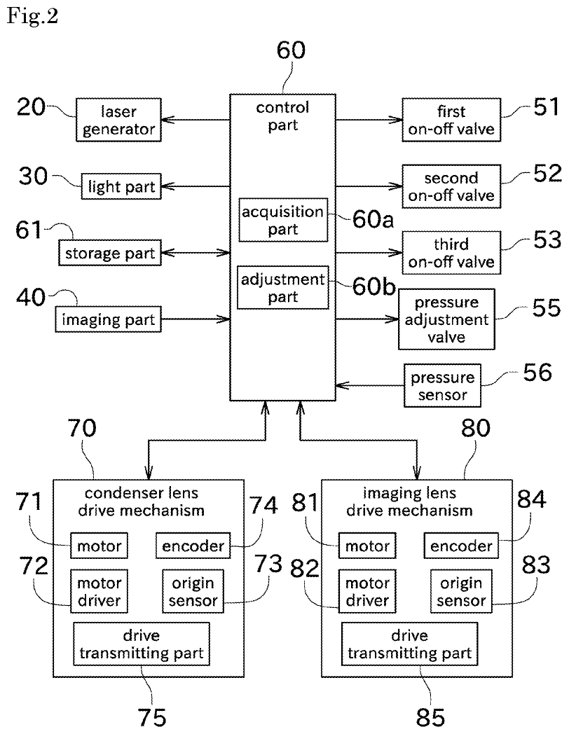

An example will now be described with reference to the drawings. First, referring to FIGS. 1 and 2, a configuration of a laser processing machine 1 of the example will be described. FIG. 1 is a schematic cross-sectional view showing the configuration of the laser processing machine 1 according to the first example. FIG. 2 is a block diagram of the laser processing machine 1.

The laser processing machine 1 processes a workpiece 110 which is an object for processing. The workpiece 110 is, for example, a plate-like metal member (sheet metal), but the workpiece 110 may be a block-like member having a large thickness or a member made of other than a metal (e.g., resins) member. The laser processing machine 1 irradiates the workpiece 110 with a laser beam to perform, for example, a punching process, a cutting process, a marking process, a welding process or the like.

The laser processing machine 1 includes a laser generator 20 that generates the laser beam, a machining head 10 that irradiates the workpiece 110 with the laser beam, and a control part 60.

The laser generator 20 is constituted of a plurality of laser diodes and an optical fiber for excitation. The light generated by the plurality of the laser diodes is collected in the optical fiber for excitation. The optical fiber for excitation is doped with a rare-earth element, and the laser beam is generated due to excitation of the rare-earth element by inputting the light from a plurality of the laser diodes. The laser beam generated by the laser generator 20 is output to the machining head 10 through the optical fiber for output 21. The laser generator 20 is not limited to a fiber laser, and the laser generator 20 may be a laser having another configuration (e.g., a carbon dioxide laser).

The machining head 10 is configured to be able to freely move in two axes (for example, in a front-back direction and a left-right direction) or three axes (in the front-back direction, the left-right direction, and a vertical direction) by performing numerical control. The laser processing machine 1 moves with respect to the workpiece 110 and irradiates the workpiece 110 with the laser beam inputted from the laser generator 20 based on machining data created in advance. This enables the workpiece 110 to be processed. The machining head 10 moves with respect to the workpiece 110 in the example, but workpiece 110 may be configured to be moved with respect to the machining head 10.

As shown in FIG. 1, a laser optical system 101, a illumination optical system 102, and a imaging optical system 103 are provided inside the machining head 10. The laser optical system 101 guides the laser beam 101a inputted from the laser generator 20 through the optical fiber for output 21 so that the laser beam 101a to reach the workpiece 110. The laser optical system 101 includes a first collimator 22, a first beam splitter 23, a condenser lens 24, a nozzle 11, and a protection plate 12. A space in which the laser beam 101a passes through (a space in which the laser optical system 101 is disposed) is referred to a laser beam passing space.

The laser beam 101a inputted to the machining head 10 is incident on the first collimator 22. The first collimator 22 converts the incident laser beam 101a into a parallel light. The optical axis of the laser beam 101a before and after passing the first collimator 22 is parallel to a horizontally direction. The first collimator 22 may be movable along the optical axis.

The laser beam 101a passed through the first collimator 22 is incident on the first beam splitter 23. The first beam splitter 23 has a function of reflecting the incident light and a function of passing through the incident light. The first beam splitter 23 may have a configuration (a dichroic mirror, a dichroic prism and the like) in which only light in a particular wavelength range is reflected and light in a remaining wavelength range pass. The first beam splitter 23 changes the optical axis of the incident laser beam 101a by 90° (from the horizontal direction to a downward of the vertical direction).

The laser beam 101a passed through the first beam splitter 23 is incident on the condenser lens 24. The condenser lens 24 is a plano-convex lens or the like and upper surface of the condenser lens 24 is convex. As a result, the condenser lens 24 converts parallel light incident from upward of the vertical direction and downward into condensed light, the condenser lens 24 converts divergent light incident from downward of the vertical direction and upward into nearly parallel light. The laser beam 101a is condensed by passing through the condenser lens 24 and is irradiated to workpiece 110 disposed under the condenser lens 24.

The nozzle 11 and the protection plate 12 are disposed under the condenser lens 24. The nozzle 11 is detachably attached under the condenser lens 24. The nozzle 11 is replaced depending on a type of process or the workpiece 110. The nozzle 11 is, for example, a truncated cone shape. The laser beam 101a is irradiated from a irradiation port 11a formed under the nozzle 11.

The protection plate 12 is disposed between the nozzle 11 and the condenser lens 24. The protection plate 12 has, for example, a disk shape, and is disposed in a space (for example, a cylindrical space having the same diameter as the protection plate 12) formed inside the machining head 10. The protection plate 12 is a member made of a material through which light passes, and the laser beam 101a and the like can pass through the protection plate 12. The protection plate 12 prevents debris and the like of the workpiece 110 from hitting the condenser lens 24 and the like at the time of process. In the following explanation, a space between the lower end of the nozzle 11 and the protection plate 12 is referred to as an inner nozzle space 14. The inner nozzle space 14 of this example includes a space surrounded by the nozzle 11 and includes a part of a space formed inside the machining head 10. In other words, the inner nozzle space 14 is a part of the laser beam passing space. The protection plate 12 closes a space so that the assist gas does not flow upward of the vertical direction, and this enables the inner nozzle space 14 to be a semi-enclosed space. The semi-enclosed space is a space in which gas does not easily move between the inside of the space and the outside of the space by closing at least a part of the space. Therefore, a pressure distribution of the inner nozzle space 14 is uniform. The semi-enclosed space is provided by sealing at least a part of the space in the machining head 10 with the protection plate 12. Since the irradiation port 11a and the like are open, the inner nozzle space 14 is not completely sealed.

The assist gas is injected from the irradiation port 11a of nozzle 11 toward the workpiece 110, for example, when performing processing to the workpiece 110 such as punching, cutting and the like. The assist gas assists cutting process of the workpiece 110 (facilitates cutting) by blowing off a portion of the workpiece 110 melted by the laser beam 101a. The laser processing machine 1 is capable of injecting three types of assist gas, namely oxygen, nitrogen, and air. The type of assist gas is selected according to the material of the workpiece 110 or the like. The laser processing machine 1 may be capable of injecting the assist gas other than the above three types. The number of types of the assist gas that can be injected may be one or two.

A first on-off valve 51 shown in FIG. 1 is provided in a pipe that supplies oxygen. The control part 60 shown in FIG. 2 controls switching between supplying oxygen or not supplying oxygen by switching between opening and closing of the first on-off valve 51. The second on-off valve 52 is provided in a pipe that supplies nitrogen. The control part 60 controls switching between supplying nitrogen or not supplying nitrogen by switching between opening and closing of the second on-off valve 52. The third on-off valve 53 is provided in a pipe that supplies air. The control part 60 controls switching between supplying air or not supplying air by switching between opening and closing of the third on-off valve 53. The assist gas is supplied to the machining head 10 through an assist gas supply tube (a gas supply part) 54.

The assist gas supply tube 54 is provided with a pressure adjustment valve 55 and a pressure sensor 56. The control part 60 adjusts an opening degree of the pressure adjustment valve 55, and this enable pressure (supply pressure) of the assist gas supplied to the machining head 10 to change. The pressure sensor 56 is disposed closer to the machining head 10 (in other words, nozzle 11) in a gas flow direction than the pressure adjustment valve 55, and the pressure sensor 56 measures the pressure of the assist gas supplied to the inner nozzle space 14. The pressure sensor 56 outputs the measured pressure to the control part 60. Since the inner nozzle space 14 to which the assist gas is supplied is a constant volume semi-enclosed space, the pressure detected by the pressure sensor 56 corresponds to the pressure in the inner nozzle space 14.

The assist gas supply tube 54 is connected to the machining head 10 and supplies the assist gas to the machining head 10. Specifically, the assist gas supplied by the assist gas supply tube 54 is supplied to the inner nozzle space 14 through the gas storage part 13. The gas storage part 13 is a space formed in the machining head 10. Specifically, the gas storage part 13 is an annular (circular) space positioned to surround the outer side of the inner nozzle space 14. The gas storage part 13 is connected to a path that supplies the assist gas stored in the gas storage part 13. The assist gas is supplied to, for example, the protection plate 12 through the path. By supplying the assist gas to the inner nozzle space 14 through the gas storage part 13, a pressure distribution of the assist gas in the inner nozzle space 14 can be uniform. The assist gas supplied to the machining head 10 is injected from the irradiation port 11a of the nozzle 11 as described above.

The illumination optical system 102 guides the illumination light 102a illuminated from the light part 30 to the workpiece 110. The illumination optical system 102 includes a second collimator 31, a second beam splitter 32, the first beam splitter 23, and the condenser lens 24. In this way, some optical components (specifically, the first beam splitter 23 and the condenser lens 24) are commonly used for the laser optical system 101 and the illumination optical system 102. In other words, the illumination light 102a passes through the laser beam passing space in the part where the optical components are common.

The light part 30 generates the illumination light 102a that illuminates the workpiece 110 for imaging. The light part 30 is, for example, a laser generator, a light emitter such as a LED (Light Emitting Diode), or a lamp such as a xenon lamp. The optical axis of the illumination light 102a generated by the light part 30 is parallel to the horizontal direction.

The illumination light 102a generated by the light part 30 is incident on the second collimator 31. The second collimator 31 converts the illumination light 102a into nearly parallel light. The second collimator 31 may be movable along the optical axis.

The illumination light 102a passing through the second collimator 31 is incident on the second beam splitter 32. The second beam splitter 32 has a function of reflecting the incident light and a function of passing through the incident light. The second beam splitter 32 may be a dichroic mirror, a half-mirror or the like. The second beam splitter 32 changes the optical axis of the incident illumination light 102a by 90° (from the horizontal direction to a downward of the vertical direction).

The illumination light 102a passing through the second beam splitter 32 is incident on the first beam splitter 23. As described above, since the first beam splitter 23 has the function of passing light, the illumination light 102a is guided so that the illumination light 102a pass through the first beam splitter 23 and is incident on the condenser lens 24 from an upper side in the vertical direction to a lower side. The laser optical system 101 and the illumination optical system 102 are common in a lower side (in the downstream side in the irradiating direction of the laser beam 101a) in the vertical direction than the first beam splitter 23. In addition, the optical paths guided by the common optical components have the same optical axis.

The illumination light 102a is condensed by the condenser lens 24 in the same manner as the laser beam 101a, and the illumination light 102a is irradiated to workpiece 110. The reflected light 103a which is the illumination light 102a reflected by the workpiece 110 is guided by the imaging optical system 103. In addition to the reflected light 103a, light which is the laser beam 101a reflected by the workpiece 110, light emitted from the melted workpiece 110 and the like may be guided by the imaging optical system 103.

The imaging optical system 103 guides the reflected light 103a to the imaging part 40. The imaging optical system 103 includes the condenser lens 24, the first beam splitter 23, the second beam splitter 32, a band-pass filter 41, a mirror 42, and a plurality of imaging lenses 43. In this way, some optical components (condenser lens 24 and the first beam splitter 23) are common to the imaging optical system 103 and the laser optical system 101. The reflected light 103a passes through the laser beam passing space in the part where the optical components are common. In addition, some optical components (condenser lens 24, the first beam splitter 23, and the second beam splitter 32) are common to the imaging optical system 103 and the illumination optical system 102. In this way, the first beam splitter 23 and the condenser lens 24 are common to the three systems, namely the laser optical system, the illumination optical system 102, and the imaging optical system 103. In addition, the optical paths guided by the common optical components have the same optical axis. The optical component of the imaging optical system 103 which is common to the laser optical system 101 is referred a first optical component, and the optical component of the imaging optical system 103 which is not common to the laser optical system 101 is referred a second optical component.

The reflected light 103a is incident on the condenser lens 24 downwardly in the vertical direction and is guided upwardly in the vertical direction. Since the reflected light 103a is divergent light and incident from downward in the vertical direction and upward, the condenser lens 24 converts the reflected light 103a into nearly parallel light, as described above. The reflected light 103a passed through the condenser lens 24 is incident on the band-pass filter 41 after passing the first beam splitter 23 and the second beam splitter 32.

Light in a predetermined wavelength range passes through the band-pass filter 41, and the band-pass filter 41 is configured to prevent light in other wavelength ranges from passing through. The band-pass filter 41 which has the characteristics of passing light of a wavelength range of the reflected light 103a and preventing passage of light of a wavelength range which reflected light of the laser beam 101a and light from the melted workpiece 110 is adopted. Instead of the band-pass filter 41, a notch filter that prevents passage of light of a predetermined wavelength range may be disposed. The reflected light 103a passed through the band-pass filter 41 is incident on the mirror 42.

The mirror 42 changes the optical axis of the incident reflected light 103a by 90° (from the vertical direction to the horizontal direction). Instead of the band-pass filter 41 and the mirror 42, a dichroic mirror or the like may be disposed.

The imaging lens 43 condenses the reflected light 103a, which is the incident collimated light. The imaging lens 43 is disposed between the band-pass filter 41 and the mirror 42, and the imaging lens 43 is also disposed between the mirror 42 and the imaging part 40. Alternatively, the imaging lens 43 may be disposed at only one of the above-mentioned locations. The number of the imaging lenses 43 included in the imaging optical system 103 may be one or plural.

The imaging part 40 is an image sensor in which a plurality of photo detectors (photodiodes or the like) are aligned side by side. The imaging part 40 converts the incident light into an electric signal, and outputs the electric signal to the control part 60. The control part 60 generates image data of the workpiece 110 based on the electric signals inputted from the imaging part 40. The control part 60 analyzes the image data of the workpiece 110 to calculate, for example, process width (widths of the removed portion of the workpiece 110 by the laser beam 101a). Since the reflected light 103a reflected by an inner wall of nozzle 11 is also incident on the imaging part 40, information written on the inner wall of nozzle 11 (such as nozzle identifying information) can be specified.

The control part 60 is an arithmetic unit such as an FPGA, an ASIC or a CPU. the control part 60 controls the respective components of the laser processing machine 1 by reading programs created in advance to RAM or the like and executing the programs. The control part 60 includes an acquisition part 60a and an adjustment part 60b. The acquisition part 60a acquires information required to adjust the focus. The adjustment part 60b adjusts the focus based on the information acquired by the acquisition part 60a. The processes performed by the acquisition part 60a and the adjustment part 60b will be described later.

The storage part 61 is a nonvolatile storage device capable of storing data, and the storage part 61 is, for example, a flash memory such as a flash disk and a memory card. The storage part 61 stores a focus adjustment table and the like, which will be described later.

Next, the focus of the laser processing machine 1 and the mechanism for focusing will be described.

The laser processing machine 1 has a plurality of focuses, and these focuses are adjusted. A focus of the workpiece 110 side of the laser optical system 101 (a first workpiece focus), a focus of the workpiece 110 side of the imaging optical system 103 (a second workpiece focus), and a focus of the imaging part 40 side of the imaging optical system 103 (an imaging focus) will be described. Also, the first workpiece focus and the second workpiece focus may be collectively referred to simply as a workpiece focus.

The focal positions of the first workpiece focus and the second workpiece focus are adjusted by moving the condenser lens 24 along the optical axis. The direction in which the condenser lens 24 moves is the same as the direction in which the workpiece focal position changes. As shown in FIG. 2, the laser processing machine 1 includes a condenser lens drive mechanism 70 that moves the condenser lens 24 along the optical axis. The condenser lens drive mechanism 70 includes a motor 71, a motor driver 72, an origin sensor 73, an encoder 74, and a drive transmitting part 75.

The control part 60 (the adjustment part 60b) can rotate the motor 71 by outputting a predetermined instruction signal (pulse signal) to the motor driver 72. The origin position is set in the motor 71. The origin sensor 73 detects that a rotational angle (a rotational phase) of the motor 71 is the origin position. The encoder 74 detects a change amount of the rotational angle of the motor 71 from the origin position. The control part 60 transmits the instruction signal to the motor driver 72 based on detected results of the origin sensor 73 and the encoder 74 so that the motor 71 can rotate until the rotation angle reaches the specified rotational angle.

The drive transmitting part 75 has a mechanism converting from a rotational motion to a linear motion such as a ball screw, a rack-and-pinion mechanism, a grooved cam or the like. The drive transmitting part 75 is connected to the motor 71 and the condenser lens 24, and the rotational motion of the motor 71 is converted to the linear motion of the drive transmitting part 75. As a result, the condenser lens 24 can be moved to one side and the other side along the optical axis. Since the control part 60 can control a rotational amount of the motor 71, the condenser lens 24 can be moved to a desired position. A driving source that performs the rotational motion is used, but a driving source that performs a linear motion (such as a linear motor) may be used.

The position of the imaging focus is adjusted by moving the imaging lens 43 along the optical axis. Since the imaging lens 43 corresponds to the second optical component described above, the focal position of the laser optical system does not change if the imaging lens 43 moves. The direction in which the imaging lens 43 moves is the same as the direction in which the imaging focal position changes. The laser processing machine 1 includes an imaging lens drive mechanism 80 that moves the imaging lens 43. The imaging lens drive mechanism 80 includes a motor 81, a motor driver 82, an origin sensor 83, an encoder 84, and a drive transmitting part 85. The respective components constituting the imaging lens drive mechanism 80 have the same configuration as the respective components constituting the condenser lens drive mechanism 70, and therefore descriptions thereof are omitted.

A plurality of the imaging lenses 43 are provided, and only one of them, two or more of them, or all of them may be configured to move. The imaging lens 43 to be moved may be disposed closer to the second beam splitter 32 than the mirror 42 or may be disposed closer to the imaging part 40 than the mirror 42.

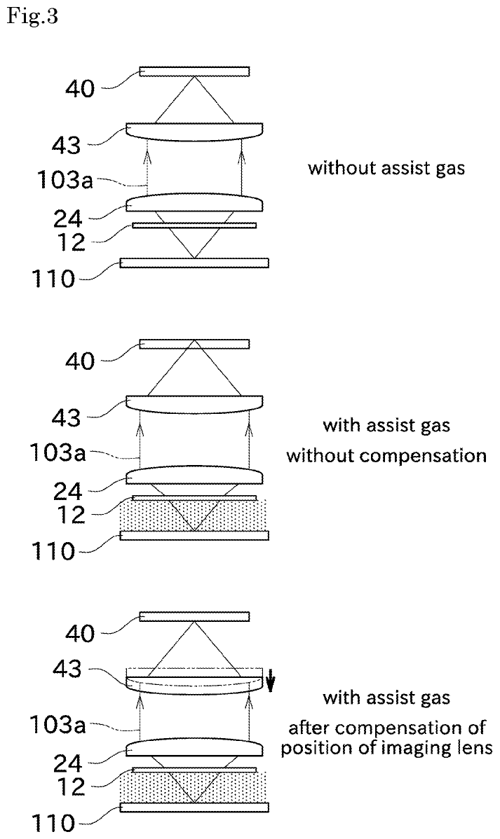

Next, referring to FIG. 3, it will be briefly described that the imaging focal position changes by supplying the assist gas and compensation method the change will be briefly described. FIG. 3 is a diagram showing a change of the imaging focal position by the assist gas and compensating method. In FIG. 3, the imaging optical system 103 is disposed in a straight line for easy understanding.

As shown in the top diagram of FIG. 3, no assist gas is mentioned, and it is assumed that the imaging focal position coincides with the element surface of the imaging part 40 (the surface of the photo detectors) in a state where the assist gas is not supplied. Further, it is assumed that the imaging focal position coincides with the element surface of the imaging part 40 while the motor 81 is in the origin position (different position may be the origin position). In this situation, as shown in the middle diagram of FIG. 3, it is assumed that the assist gas is supplied. Since the assist gas fills a space below the protection plate 12 and above the workpiece 110, the pressure in the space changes (usually increases). The reflected light 103a passes through the space.

It is known that a refractive index of the gas is proportional to the pressure. Thus, depending on the supply pressure of the assist gas, the refractive index of the inner nozzle space 14 changes (for example, as the supply pressure of assist gas usually increases, the refractive index increases). Accordingly, a refractive angle of the reflected light 103a changes so that the imaging focal position changes as shown in the middle diagram of FIG. 3. As a result, the imaging focal position does not coincide with the element surfaces of the imaging part 40. In the situation, the image acquired by the imaging part 40 is blurred.

On the other hand, the imaging lens 43 is moved by the imaging lens drive mechanism 80 so that the imaging focal position can change. Therefore, when the imaging lens 43 is moved by an amount changed by supplying assist gas, the imaging focal position can coincide with the element surface of the imaging part 40 as shown in the lower diagram of FIG. 3. Especially, since the inner nozzle space 14 is the semi-enclosed space having the constant volume and the pressure distribution of the inner nozzle space 14 is uniform, this enables the correlation of the pressure and the refractive index of the inner nozzle space 14 to be high. Therefore, it is possible to estimate an appropriate change amount of the imaging focal position. Since the refractive index of gas also depends on the specific gravity of gas, it is preferable to move the imaging lens 43 in accordance with not only gas pressure of the assist gas but also the type of the assist gas.

A first process mode of processing and imaging the workpiece 110 with supplying the assist gas and a second process mode of processing and imaging the workpiece 110 without supplying the assist gas can be performed. Therefore, in the first process mode, the process and the imaging are performed while changing the position of the imaging focal position in accordance with the assist gas. In the second process mode, the process and imaging are performed while motor 81 coincides with the origin position. In the second process mode, the position of the imaging lens 43 may be adjusted in accordance with thickness of the workpiece 110, length of the nozzle 11, a position of the condenser lens 24, and the like.

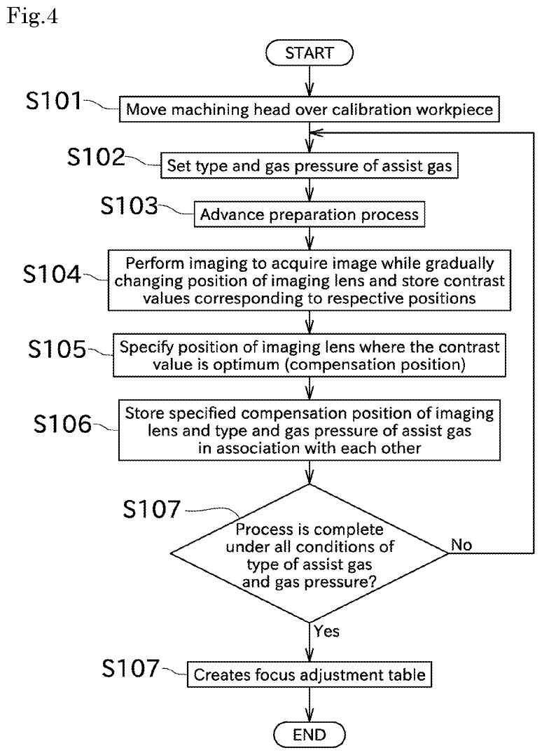

Next, an initial setting of adjusting the imaging focus (specifically, steps of creating the focus adjustment table) will be described with reference to the flow chart of FIG. 4. FIG. 4 is a flow chart showing steps of creating the focus adjustment table.

First, the steps of creating the focus adjustment table will be described. The focus adjustment table is a table in which a gas pressure of the assist gas and a focal information are associated with each other. The focal information is a change amount of the imaging focal position according to the gas pressure of the assist gas, or the focal information is information for compensating the change amount. The focal information of this example is a position of the imaging lens 43 that compensates for the change of the imaging focal position (information for compensating the change amount of the imaging focal position, in other words, information having a one-to-one correspondence with the change amount). As described above, since the imaging focal position also depends on the type of the assist gas, the focus adjustment table is created for each type of the assist gas.

First, the control part 60 moves the machining head 10 over a calibration workpiece (S101). The calibration workpiece is a member that acquires the focus adjustment table and the like, and is not an object for actual process. Next, the control part 60 set the type and the gas pressure of the assist gas (S102). To create the focus adjustment table, the focal information corresponding to the type and the gas pressure of assist gas is required so that various conditions are sequentially set.

Next, the control part 60 performs an advance preparation process (S103). The advance preparation process is a process performed in advance to image by the imaging part 40. Specifically, the advance preparation process is a process of starting an injection of the assist gas set the type and the pressure, moving the imaging lens 43 to the origin position, and making the light part 30 illuminate.

Next, the control part 60 performs imaging to acquire the image while gradually changing the position of the imaging lens 43, and stores contrast values corresponding to the respective positions (S104). The contrast value is a value indicating how steeply the brightness of the image acquired by imaging changes. More specifically, a difference in luminance between a pixel A and a pixel around the pixel A (for example, one pixel around the pixel A) is calculated. The larger the absolute value of the calculated value is, the steeper the luminance changes. The contrast value is calculated based on the result of performing the process not only at the pixel A but also at all or a predetermined range of pixels. It can be determined that the higher the contrast value is, the sharper the image is (the imaging focus is closer to the element surface of the imaging part 40). The control part 60 stores the contrast value calculated above and the position of the imaging lens 43 in association with each other in the storage part 61.

After briefly changing the position of the imaging lens 43, the control part 60 specifies the position of the imaging lens 43 (in particular, the rotational amount of the motor 81 from the origin position) at which the contrast value is the optimum or largest (S105). Then, the control part 60 stores the specified position of the imaging lens 43 and the type and gas pressure of the assist gas in association with each other in the storage part 61 (S106). As a result, the position of the imaging lens 43 (a position for coincide the imaging focal position with the element surface of the imaging part 40, hereinafter referred to as compensation position) according to the type and the gas pressure of the assist gas is stored. The gas pressure of the assist gas stored here is a set value, but may be a measured value measured by the pressure sensor 56. Instead of the process, since data indicating the association between the position of the imaging lens 43 acquired in the step S104 and the contrast value is discrete, the compensation position of the imaging lens 43 may be calculated by using data acquired by interpolating between the respective positions. The control part 60 also stops the illumination of the light part 30 after acquiring images by briefly changing the position of imaging lens 43.

Next, the control part 60 determines whether or not the compensation positions of the imaging lens 43 has been acquired under all conditions of the type of the assist gas and the gas pressure (S107). If any other condition remains, the control part 60 sets this condition (S102) and performs processing from step S103 to step S106 to acquire the compensation positions of the imaging lens 43.

When the control part 60 acquires the compensation positions of the imaging lens 43 under all conditions, the control part 60 creates the focus adjustment table (S108). The focus adjustment table is a table in which the gas pressure of the assist gas is associated with the compensation position of the imaging lens 43 of the gas pressure. The focus adjustment table is created for each type of the assist gas. The created focus adjustment table is stored in the storage part 61. The focus adjustment table may be stored in a storage device provided outside the laser processing machine 1 and connected to the laser processing machine 1 via a network. The laser processing machine 1 receives the focus adjustment table from the storage device as required.

As described above, the focus adjustment table is created by actually measuring. Alternatively, by inputting the type and the gas pressure of the assist gas, a relational expression can be created that can determine the compensation position of the imaging lens 43. Specifically, since the refractive index of gas can be determined based on the specific gravity and the pressure of the gas, the refractive index of the assist gas can be determined based on the type and the gas pressure of the assist gas. The refractive index of the other parts, the specifications of the optical components, and the distances between the optical components are known. Therefore, the above-mentioned relational expression can be created by performing the calculation based on these.

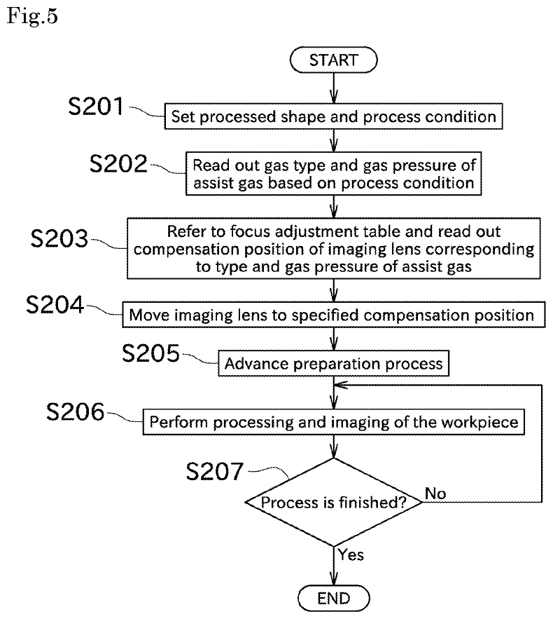

Next, steps of adjusting the imaging focal position based on the focus adjustment table created above will be described with reference to the flow chart of FIG. 5. FIG. 5 is a flow chart showing steps adjusting the imaging focal position by using the focus adjustment table. The acquisition part 60a of the control part 60 performs a step of acquiring the focal information described above. The adjustment part 60b adjusts the imaging focal position based on the focal information acquired by the acquisition part 60a.

First, the control part 60 performs setting processed shapes and process conditions of the workpiece 110 on the basis of information inputted from an operator or information received from outside (S201). Next, the control part 60 reads out the gas type and the gas pressure of the assist gas based on the process condition (S202). The control part 60 (the acquisition part 60a) refers to the focus adjustment table stored in the storage part 61, and the control part 60 reads out the compensation position (the focal information) of the imaging lens 43 corresponding to the type and the gas pressure of the assist gas (S203, acquisition step). Since both the gas pressure and the corresponding compensation position are discretely described in the focus adjustment table, the control part 60 may calculate the compensation position of the imaging lens 43 by using data acquired by interpolating data of the focus adjustment table.

Next, the control part 60 (the adjustment part 60b) controls the imaging lens drive mechanism 80 to move the imaging lens 43 to the read compensation position (S204, adjustment step). This enables the imaging focal position to be coincide with the element surface of the imaging part 40.

Then, the control part 60 performs the same advance preparation process as step S103 (S205), and perform processing and imaging of the workpiece 110 (S206). Since the imaging focal position coincides with the element surface of the imaging part 40 as described above, it is possible to constantly acquire a clear image of the workpiece 110. Thus, the control part 60 can acquire values of a process width of the workpiece 110 while being processed the workpiece 110. When the imaging lens 43 moves, magnification of the image acquired by the imaging part 40 changes. Therefore, the control part 61 calculates the magnification of the image in accordance with a moving distance of the imaging lens 43 so that the control part 61 can acquire a more accurate process width.

If the process width differs from the target value, the control part 60 may perform processing of compensating it (e.g., a process of moving the condenser lens 24). Further, the control part 60 determines whether the process is completed or not (S207), a series of processes is completed if it is determined that the process is completed. After it is determined that the process is completed, the control part 60 stops the illumination of the light part 30.

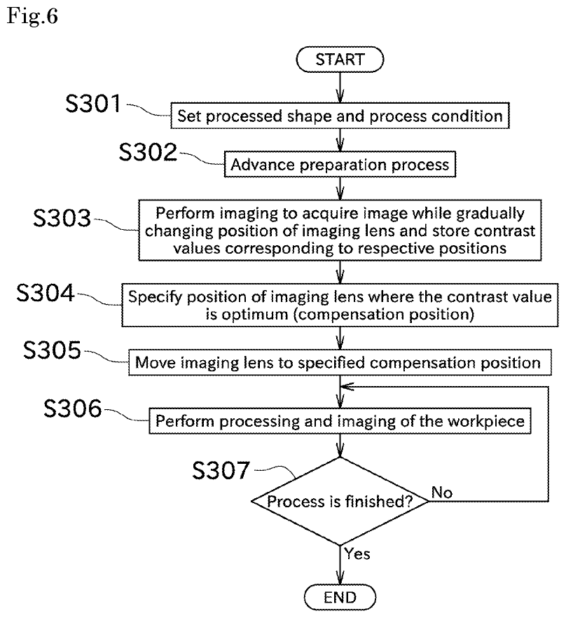

Next, referring to FIG. 6, a second example will be described. FIG. 6 is a flow chart showing steps of adjusting the imaging focal position in the second example. In the second example and subsequent descriptions, descriptions of the same or similar processes as the first example may be simplified. It is also possible to apply the features described in the first example to the second example and later.

In the first example, measurement is performed in advance to create the focus adjustment table, and the compensation position of the imaging lens 43 is acquired by using the focus adjustment table immediately before the process. On the other hand, in the second example, measurement is performed immediately before the process to acquire the compensation position of the imaging lens 43. Hereinafter, a specific description will be described.

First, the control part 60 performs setting of the processed shape and the process condition of the workpiece 110 the same as step S201 (S301). Next, the control part 60 performs the advance preparation process similar to step S103 (S302). The control part 60 performs imaging to acquire the image while gradually changing the position of the imaging lens 43 and stores the contrast values corresponding to the respective positions (S303), similar to step S104. After briefly changing the position of the imaging lens 43, the control part 60 (the acquisition part 60a) specifies the compensation position of the imaging lens 43 (the focal information) at which the contrast value is the optimum (S304, acquisition step), similar to step S105.

In the first example, the compensation position of the imaging lens 43 is determined while the type and the pressures of the assist gas are changed to create the focus compensation table, but in the second example there is no need to create the focus compensation table. Therefore, the control part 60 (the adjustment part 60b) moves the imaging lens 43 to the specified compensation position (S305, adjustment step). Next, the control part 60 performs processing and imaging of the workpiece 110 (S306). Further, the control part 60 determines whether the process is completed or not (S307), a series of processes is completed if it is determined that the process is completed. Similar to the first example, the second example can calculate the accurate values of the process width of the workpiece 110 while processing the workpiece 110.

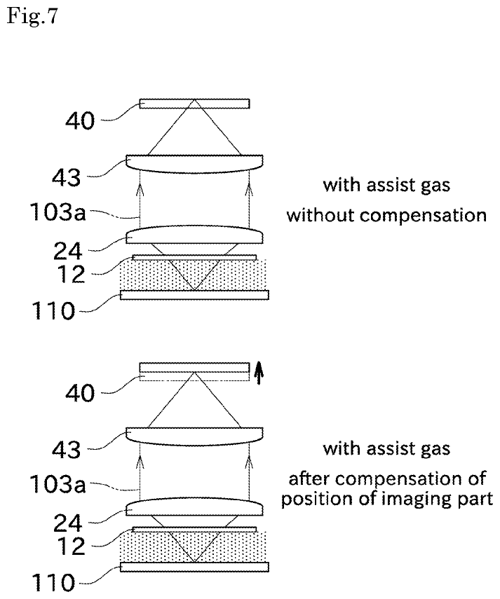

Next, a third example will be described with reference to FIG. 7. FIG. 7 is an explanatory view showing principles of adjusting the imaging focal position in the third example.

In the first example, the imaging focal position is adjusted by adjusting the position of the imaging lens 43 to coincide the imaging focal position with the element surface of the imaging part 40. On the other hand, in the third example, as shown in FIG. 7, by adjusting the position of the imaging part 40, the imaging focal position coincides with the element surfaces of the imaging part 40. The mechanism of adjusting the position of the imaging part 40 may be the same as the mechanism of the first example. The configuration of the third example can be used in a method of creating the focus adjustment table in advance such as first example, or can be used in a method of performing adjustment before processing such as the second example. The first and third examples may be combined to adjust the positions of both the imaging part 40 and the imaging lens 43.

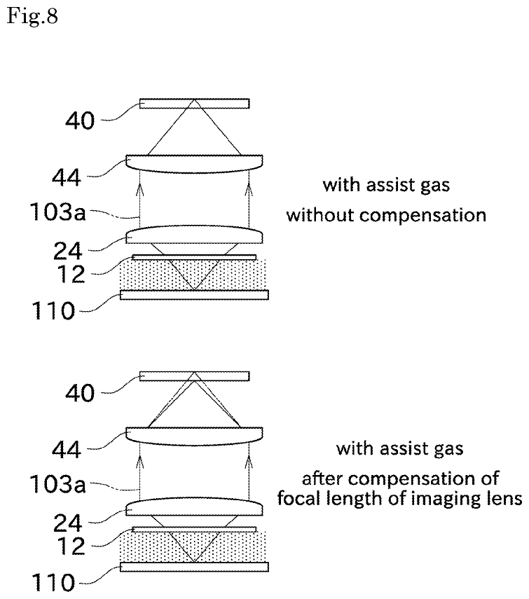

Next, a fourth example will be described with reference to FIG. 8. FIG. 8 is an explanatory view showing principles of adjusting the imaging focal position in the fourth example.

In the first and the third examples, the imaging focal position coincides with the element surface of the imaging part 40 by adjusting the positions of the optical components. On the other hand, in the fourth examples, a variable focus lens 44 is disposed instead of the imaging lens 43. The variable focus lens 44 constitutes a part of the imaging optical system 103. The variable focus lens 44 is filled with a conductive liquid and a non-conductive liquid and can change the focus by changing a form of the conductive liquid by applying electric charges under the control of control part 60 (adjustment part 60b). The variable focus lens 44 may have another configuration as long as the focus can change without changing the position.

By changing the focus of the variable focus lens 44, as shown in FIG. 8, the imaging focal position can coincide with the element surface of the imaging part 40 without moving the variable focus lens 44. The configuration of the fourth example can be used in a method of creating the focus adjustment table in advance such as the first example, or can be used in a method of performing adjustment before processing such as the second example. The configuration is combined with at least one of the first and third examples, and the focus of the imaging lens 43 or the position of at least one of the imaging lens 43 and the imaging part 40 may be adjusted.

As described above, the laser processing machine 1 of this example includes the laser generator 20, the laser optical system 101, the assist gas supply tube 54, the light part 30, the imaging part 40, the imaging optical system 103, the acquisition part 60a, and the adjustment part 60b. The laser generator 20 generates the laser beam 101a that processes the workpiece 110. The laser optical system 101 includes the condenser lens 24 that condenses the laser beam 101a generated by the laser generator 20, the nozzle 11 disposed under the condenser lens 24, and the protection plate 12 disposed between the condenser lens 24 and the nozzle 11. The inner nozzle space 14 located between the lower end of the nozzle 11 and the protection plate 12 is the constant volume semi-enclosed space. The laser optical system 101 guides the laser beam 101a so that the laser beam 101a is irradiated to the workpiece 110 through the irradiation port 11a which is positioned at the lower end of the nozzle 11. The assist gas supply tube 54 adjusts pressure of the assist gas and supplies the assist gas which is a gas injected from the irradiation port 11a and assists processing of the workpiece 110 by the laser beam 101a, and supplies the assist gas to the inner nozzle space. The light part 30 generates the illumination light 102a that illuminates the workpiece 110. The imaging part 40 images the workpiece 110 by detecting the reflected light 103a which is the illumination light 102a from the light part 30 reflected by the workpiece 110 through a portion of the laser beam passing space. The imaging optical system 103 guides the reflected light 103a to the imaging part 40. The acquisition part 60a acquires the focal information which is the change amount of the imaging focal position according to the gas pressure of the assist gas in the inner nozzle space 14 or is information that compensates for the change amount (acquisition step). The adjustment part 60b adjusts at least one of the imaging focal position and the position of the imaging part 40 based on the focal information acquired by the acquisition part 60a (adjustment step).

As a result, since the inner nozzle space 14 (the semi-enclosed space) having the constant volume is formed by the lower end of the nozzle 11 and the protection plate 12, the pressure change of the inner nozzle space 14 and the refractive index change of the inner nozzle space 14 are correlated with each other. Therefore, the adjustment according to the pressure of the inner nozzle space by the adjustment part 60b enables the acquisition part 60a to acquire the clear image of the workpiece 110.

In the laser processing machine 1 of the above example, the assist gas supply tube 54 includes the pressure adjustment valve 55 that adjusts the supply pressure of the assist gas and the pressure sensor 56 disposed at the nozzle side than the pressure adjustment valve.

Accordingly, since the pressure of the inner nozzle space 14 can be detected by the pressure sensor 56, the adjustment part 60b can perform more appropriately adjustment.

In the laser processing machine 1 of the above example, the gas storage part 13 which is the annular space surrounding the inner nozzle space 14 is formed, and the assist gas is supplied to the inner nozzle space 14 through the gas storage part 13.

As a result, since the pressure distribution of the inner nozzle space 14 is uniform, the inner nozzle space 14 is static. That cause the correlation of the pressure and the refractive index of the inner nozzle space 14 to be high. Accordingly, the adjustment part 60b can perform more appropriately adjustment.

In the laser processing machine 1 of the above example, the assist gas supply tube 54 is capable of supplying the assist gas selected from a plurality of types of the assist gas. The focal information is the change amount of the imaging focal position according to the type and the gas pressure of the assist gas or the information for compensating the change amount.

Accordingly, since the adjustment part 60b adjusts taking into account not only the gas pressure of the assist gas but also the type of the assist gas, the clearer image of the workpiece 110 can be acquired.

In the laser processing machine 1 of the above example, the acquisition part 60a acquires the focal information based on the data in which the gas pressure of the assist gas and the focal information corresponding to the gas pressure are associated with each other and the gas pressure supplied by the assist gas supply tube 54.

This enables the acquisition part 60a to acquire the focal information with a simple process.

In the laser processing machine 1 of the above example, the acquisition part 60a acquires the focal information by analyzing the image of the workpiece 110 acquired by the imaging part 40 in a state where the laser beam 101a is not irradiated to the workpiece 110 and the assist gas supply tube 54 supplies the assist gas.

Accordingly, since there is the relationship between the imaging focal position and the image of the workpiece 110, the acquisition part 60a acquires the appropriate focal information by analyzing the image.

In the laser processing machine 1 of the above example, the acquisition part 60a calculates the focal information based on the gas pressure of the assist gas supplied by the assist gas supply tube 54 and the relational expression indicating the relationship between the gas pressure and the focal information.

As a result, it is possible to reduce the amount of processes to be performed in advance compared to a configuration creating databases in which the gas pressure and the focal information are associated with each other.

In the laser processing machine 1 of the above example, the adjustment part 60b adjusts at least one of the imaging focal position and the position of the imaging part 40 before the workpiece 110 is processed by the laser generator 20 and the assist gas supply tube 54.

As a result, the process can start with the imaging focal position coinciding with the imaging part 40.

In the laser processing machine 1 of the above example, the adjustment part 60b further adjusts the workpiece 110 focal position of the laser optical system 101 and the imaging optical system 103.

As a result, the process is performed while the workpiece 110 focal positions of the laser optical system 101 and the imaging optical system 103 coincides with the surfaces of the workpiece 110.

In the laser processing machine 1 of the above example, the imaging optical system 103 includes the imaging lens 43 for imaging the image on the imaging focus. The adjustment part 60b adjusts the imaging focal position by moving the imaging lens 43 along the optical axis.

This makes it possible to coincide the imaging focal position to the imaging part 40 with a simple configuration.

In the laser processing machine 1 of the above example, the adjustment part 60b coincides the position of the imaging part 40 to the imaging focal position by moving the imaging part 40 along an optical axis.

This makes it possible to coincide the imaging focal position to the imaging part 40 with a simple configuration.

In the laser processing machine 1 of the above example, the imaging optical system 103 includes the variable focus lens 44 being capable of changing the focal length. The adjustment part 60b adjusts the imaging focal position by changing the focal length of the variable focus lens 44.

Accordingly, a drive mechanism that drives the imaging lens, the imaging part 40, and the like can be omitted when the adjustment is performed by using only the variable focus lens 44.

In the laser processing machine 1 of the above example, the imaging optical system 103 includes the first optical component common to the laser optical system 101 and the second optical component not common to the laser optical system 101. The adjustment part 60b adjusts at least one of the imaging focal position and the position of the imaging part 40 by using the imaging part 40 or the second optical component (imaging lens 43).

This prevents the focal position of the laser optical system 101 from changing when the imaging focal position is adjusted.

In the laser processing machine 1 of the above example, the imaging part 40 can perform the first process mode for imaging the workpiece 110 while the assist gas supply tube 54 supplies the assist gas and the second process mode for imaging the workpiece 110 while the assist gas supply tube 54 does not supply the assist gas. Only the first process mode of the first process mode and the second process mode compensates the change of the imaging focal position according to the gas pressure of the assist gas.

This make it possible to provide the laser processing machine 1 in which the clear image of the workpiece 110 can be used both in processing with the assist gas and in processing without the assist gas.

Although preferred examples have been described above, the configurations above can be modified, for example, as follows.

The laser optical system 101, the illumination optical system 102, and the imaging optical system 103 described above are examples, and types and the numbers of optical components constituting the optical systems may be different from these systems. In the above examples, the optical axes of the respective optical systems change at right angles only once, but in at least one optical system, the optical axes may be straight or may change a plurality of times.

In the above examples, the position of the imaging focal position or the imaging part 40 is adjusted based on both the type of the assist gas and the gas pressure. Alternatively, since the effects of the type of the assist gas differences are minor, the above adjustments may be performed based only on the gas pressure of assist gas.

1-15. (canceled)

16. A laser processing machine comprising:
a laser generator that generates a laser beam to process a workpiece;
a laser optical system including a condenser lens that condenses the laser beam generated by the laser generator, a nozzle disposed under the condenser lens, and a protection plate disposed between the condenser lens and the nozzle, and guides the laser beam so that the laser beam is irradiated to the workpiece through an irradiation port positioned at a lower end of the nozzle, the nozzle having an Inner nozzle space located between the lower end of the nozzle and the protection plate that is a constant volume semi-enclosed space;
a gas supply part that adjusts pressure of an assist gas injected from the irradiation port and which assists processing of the workpiece by the laser beam, and supplies the assist gas to the inner nozzle space;
a light part that generates illumination light that illuminates the workpiece;
an imaging part that images the workpiece by detecting a reflected light which is the illumination light from the light part reflected by the workpiece through a portion of laser beam passing space;
an imaging optical system that guides the reflected light to the imaging part;
an acquisition part that acquires focal information which is a change amount of an imaging focal position according to gas pressure of the assist gas in the inner nozzle space or is information that compensates for the change amount; and
an adjustment part that adjusts at least one of the imaging focal position and the position of the imaging part based on the focal information acquired by the acquisition part.

17. The laser processing machine according to claim 16, wherein the gas supply part includes a pressure adjustment valve that adjusts a supply pressure of the assist gas and a pressure sensor disposed at closer to a nozzle than the pressure adjustment valve.

18. The laser processing machine according to claim 16, wherein a gas storage part which is an annular space surrounding the inner nozzle space is formed, and the assist gas is supplied to the inner nozzle space through the gas storage part.

19. The laser processing machine according to claim 16, wherein
the gas supply part is capable of supplying the assist gas selected from a plurality of types of the assist gas, and
the focal information is the change amount of the imaging focal position according to the type and the gas pressure of the assist gas or the information compensating for the change amount.

20. The laser processing machine according to claim 16, wherein the acquisition part acquires the focal information based on data in which the gas pressure of the assist gas and the focal information according to the gas pressure are associated with each other and the gas pressure supplied by the gas supply part.

21. The laser processing machine according to claim 16, wherein the acquisition part acquires the focal information by analyzing an image of the workpiece acquired by the imaging part in a state where the laser beam is not irradiated to the workpiece and the gas supply part supplies the assist gas.

22. The laser processing machine according to claim 16, wherein the acquisition part calculates the focal information based on the gas pressure of the assist gas supplied by the gas supply part and a relational expression indicating a relationship between the gas pressure and the focal information.

23. The laser processing machine according to claim 16, wherein the adjustment part adjusts at least one of the imaging focal position and the position of the imaging part before the workpiece is processed by the laser generator and the gas supply part.

24. The laser processing machine according to claim 16, wherein the adjustment part further adjusts workpiece focal positions of the laser optical system and the imaging optical system.

25. The laser processing machine according to claim 16, wherein
the imaging optical system includes a imaging lens for imaging an image on a imaging focus, and
the adjustment part adjusts the imaging focal position by moving the imaging lens along an optical axis.

26. The laser processing machine according to claim 16, wherein the adjustment part coincides the position of the imaging part with the imaging focal position by moving the imaging part along an optical axis.

27. The laser processing machine according to claim 16, wherein
the imaging optical system includes a variable focus lens being capable of changing a focal length, and
the adjustment part adjusts the imaging focal position by changing the focal length of the variable focus lens.

28. The laser processing machine according to claim 16, wherein
the imaging optical system includes a first optical component common to the laser optical system and a second optical component not common to the laser optical system, and
the adjustment part adjusts at least one of the imaging focal position and the position of the imaging part by using the imaging part or the second optical component.

29. The laser processing machine according to claim 16, wherein
the imaging part can perform a first process mode that processes and images the workpiece while the gas supply part supplies the assist gas and a second process mode that processes and images the workpiece while the gas supply part does not supply the assist gas, and only the first process mode of the first process mode and the second process mode compensates the change of the imaging focal position according to the gas pressure of the assist gas.

30. A focus adjustment method of a laser processing machine, wherein the laser processing machine comprises:
a laser generator that generates a laser beam to process a workpiece;
a laser optical system including a condenser lens that condenses the laser beam generated by the laser generator, a nozzle disposed under the condenser lens, and a protection plate disposed between the condenser lens and the nozzle, and guides the laser beam so that the laser beam is irradiated to the workpiece through an irradiation port positioned at a lower end of the nozzle, the nozzle having an Inner nozzle space located between the lower end of the nozzle and the protection plate that is a constant volume semi-enclosed space;
a gas supply part that adjusts pressure of an assist gas which is a gas injected from the irradiation port and assists the processing of the workpiece by the laser beam, and supplies the assist gas to the inner nozzle space;
a light part that generates illumination light that illuminates the workpiece;
an imaging part that images the workpiece by detecting a reflected light which is the illumination light from the light part reflected by the workpiece through a portion of laser beam passing space; and
an imaging optical system that guides the reflected light to the imaging part,
the focus adjustment method including
an acquisition step of acquiring focal information which is a change amount of an imaging focal position according to a gas pressure of the assist gas in the inner nozzle space or is information compensating for the change amount, and
an adjustment step of adjusting at least one of the imaging focal position and the position of the imaging part based on the focal information acquired in the acquisition step.
